(19) United States
(12) Patent Application Publication
(10) Pub. No.: US 2014/0202390 A1
(43) Pub. Date: Jul. 24, 2014

(54) Bedding For Bird Coops

(71) Applicants: Theodore J. McNamara, Milwaukee, WI (US); James T. Crunkleton, III, Waynesburg, KY (US)

(72) Inventors: Theodore J. McNamara, Milwaukee, WI (US); James T. Crunkleton, III, Waynesburg, KY (US)

(21) Appl. No.: 13/975,879

(22) Filed: Aug. 26, 2013

Related U.S. Application Data
(60) Provisional application No. 61/755,746, filed on Jan. 23, 2013.

(51) Int. Cl. A01K 31/00; A01K 45/00

(52) U.S. Cl. CPC A01K 31/007; A01K 45/00
USPC 119/6.8; 119/28.5

(57) ABSTRACT

Disclosed are synthetic structured mattresses for bird coop bedding. There is a slab/nesting pad made of a porous plastic foam. In one form the foam is suitable to permit liquid to readily drain through it when the slab is washed. An array of tufts are configured to encourage scratching thereof if a bird is placed thereby. In some forms an upper support surface of the slab may be formed with a depression or cutout suitable to position a laid egg at a defined place. The depression may be formed by molding, or by a two layer structure.

### CROSS-REFERENCE TO RELATED APPLICATION

This application claims priority based on U.S. provisional application 61/755,746 which was filed on Jan. 23, 2013.

### STATEMENT OF FEDERALLY SPONSORED RESEARCH OR DEVELOPMENT

Not applicable.

### BACKGROUND OF THE INVENTION

The present invention relates to structured synthetic drainable foam material used as bird coop bedding. More particularly it relates to washable sheets of plastic open cell foam, preformed with scratch encouraging surfaces and/or egg holding depressions, for placement on bird coop floors as nesting pads.

Traditionally chickens and various other commercially raised birds have been raised on straw, hay or other natural bedding. Once the chickens have been on that bedding for a while (e.g. defecating on it), one disposes of the straw or the like, and puts fresh straw or the like down. This is somewhat costly, and in any event creates a waste disposal problem.

Other chickens have been kept in coops that have simple concrete slab floors that can be rinsed down without the need to throw anything away. However, this raises some animal cruelty concerns, and in any event may inhibit nesting and egg laying.

Others allow chickens to run freely in a larger penned area (e.g. free range chickens). However, this can complicate nesting, egg laying, and particularly harvesting.

U.S. Pat. No. 7,208,081 teaches a reticulated foam gutter filter material that can permit liquid to readily pass through it, while presenting a top slab-like surface for holding leaves out of a gutter. However, using such material for a very different purpose such as bedding in unmodified fashion would create other problems, particularly insofar as the willingness of birds to calmly accept extended periods on such an unusual material.

U.S. Pat. Nos. D512,536, 5,159,896 and 6,374,774 teach synthetic materials provided with various upper structures. However, these structures were costly to make, were difficult to clean if soiled, and did not easily accommodate eggs or chicken scratching.

U.S. Pat. No. 2,592,430 taught a bedding in the form of a sink where liquid could flow out the bottom of the sink.

U.S. Pat. No. 6,058,883 taught the concept of forming animal bedding out of a synthetic material that was washable (rather than just throwing the bedding away when soiled). However, this was a pellet based system that was somewhat clumsy to clean and use.

Various foam materials have also been used in mattresses for humans, dogs and other animals, albeit most typically not in contexts designed for periodic washing after an animal regularly defecates thereon.

As such, there is a need for further improved bird beddings, particularly those having structures which calm birds, facilitate washing so as to extend bedding life, and optionally position laid eggs to facilitate automated harvesting.

### SUMMARY OF THE INVENTION

The present invention provides a sheet that is made of a foam material (e.g. preferably a reticulated foam material such as polyether plastic) useful as a mattress/nesting pad for birds. Such birds will defecate and urinate directly on the mattress. When the mattress is soiled one can temporarily move the birds, wash down the “bedding”, and cause the soiled liquid to readily drain through the bedding to a disposal drain (such as a sewer).

In one aspect the invention provides the sheet with a grid of cuts on its top so that a “forest” of about ½ inch (preferably less than one inch) foam extensions/tufts project up. This creates a surface that a bird such as a chicken will want to scratch at. Birds like chickens are more calm (and thus more likely to lay eggs) if they can periodically scratch what they perceive to be suitable scratch areas.

There can also be a depression/cutout near the center of the mattress top surface (where the bird will mostly sit) to hold any laid eggs and help position the bird optimally. This can be created either by molding the foam with an integral depression, or by using a bottom slab part and a top slab part (a two layer structure) where the top slab has a preformed cut out.

It will therefore be appreciated that the present invention provides one or more advantages in various embodiments. For example, the washability of the sheets extends the life of the product, reduces noxious odors, and reduces bedding waste. The scratch surface improves egg laying productivity. The depressions can reduce egg breakage and save harvesting time in large facilities.

The foam material can easily be cut or formed to be suitable for placement in compact and varied coop spaces. It is also available at a practical cost.

These and still other advantages of the present invention will become more apparent, and the invention will be better understood, by reference to the following description of preferred embodiments of the present invention.

### BRIEF DESCRIPTION OF THE DRAWINGS

FIG. 1 is an upper perspective view of a first, single layer, embodiment of the present invention;

FIG. 2 is a view similar to FIG. 1, but of a second, double layer embodiment of the present invention;

FIG. 3 is a top view of the top layer thereof;

FIG. 4 is a front elevational view thereof; and

FIG. 5 is a side elevational view thereof.

### DESCRIPTION OF THE PREFERRED EMBODIMENTS

Structured synthetic foam bedding of the present invention is particularly well suited for use on the floor of chicken coops. The idea is to provide a mattress/nesting pad in the form of a durable foam material slab that can be washed and thus used for an extended period. The material will also preferably readily drain wash liquid through it so as to permit washing without moving the bedding, and so as to quickly dry the bedding. Particularly desirable foams are sheets of plastic open cell reticulated foam, such as a polyether foam of about 15 cells (e.g. 10-20) per square inch. This material is particularly well accepted by chickens.

In accordance with the present invention, and as noted below, it is important to modify the top of the foam via segmentation (e.g. a grid of cuts) to encourage birds to scratch and to accept the material. It is also desirable to provide a central cut-out/depression to hold eggs which might be laid and encourage preferred bird positioning. Note that making the tufts too long can lead to tangling, and suppress scratching.

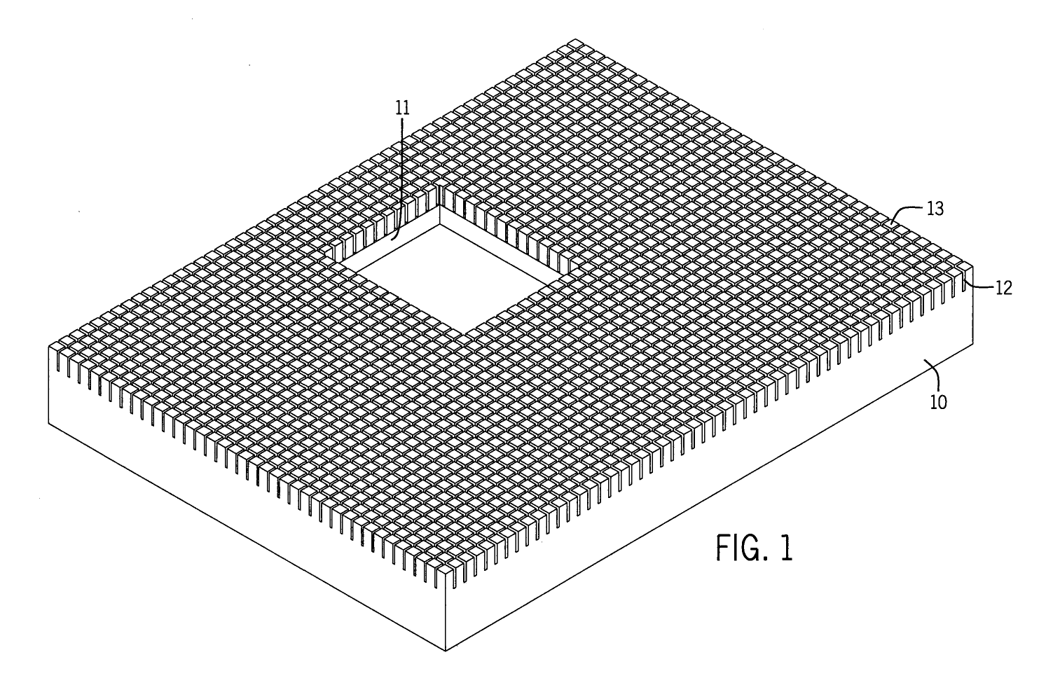

FIG. 1 shows a first, single layer, slab 10 of the invention. A central depression 11 is molded into the material and shallow cross cuts 12 are made to create tiny tufts 13. A chicken or the like will want to scratch at tufts 13, and will be calmed thereby.

The chicken (or other bird) sits over or near depression 11, thereby optimally spacing chickens in the coop, and in any event consistently positioning eggs as they are laid. In a large production facility consistent egg positioning can facilitate automated egg harvesting equipment.

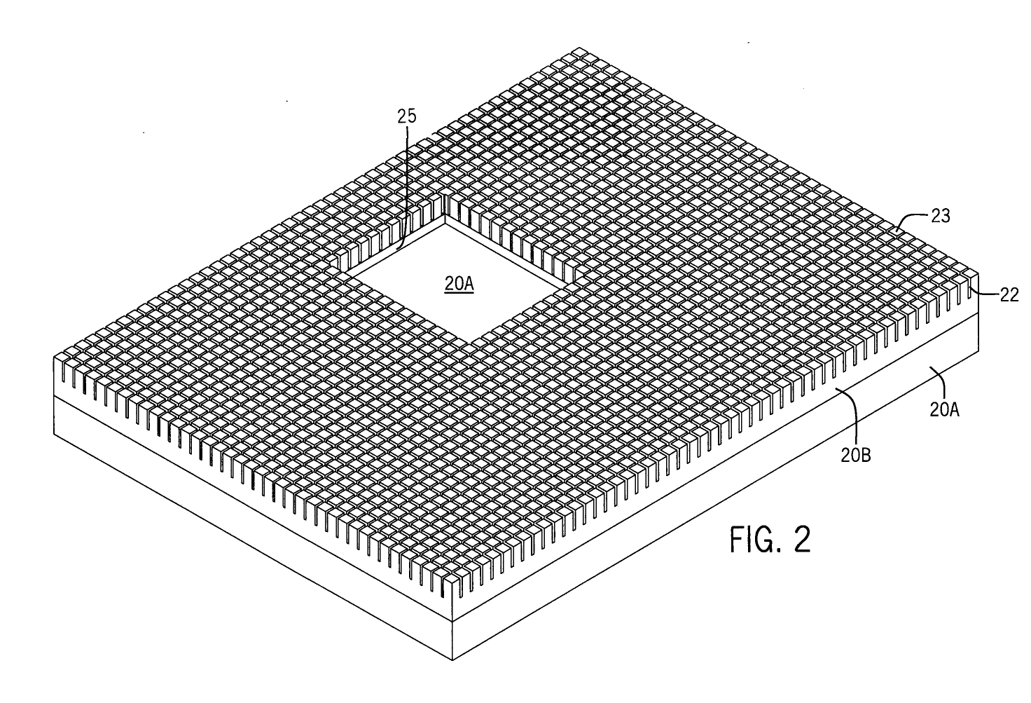

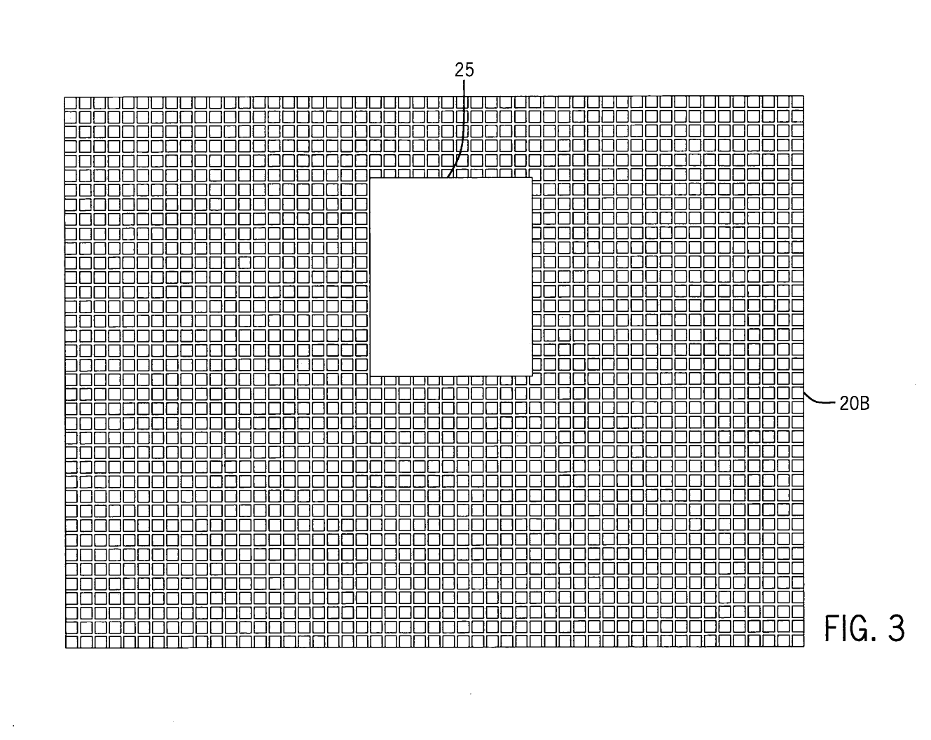

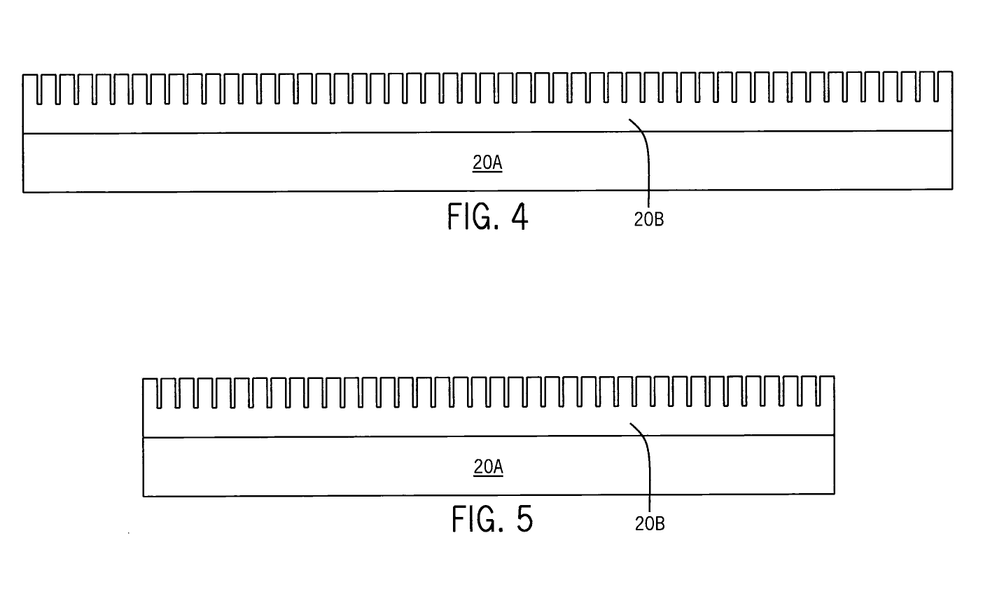

FIGS. 2-5 show a second, double layer, embodiment 20A/20B. Bottom layer 20A is a sheet of the foam material, unmodified. Upper layer 20B is a second such sheet, but with shallow cuts 22 forming tufts 23 (similar to 12/13), and a cut out 25 rather than a formed depression 11. This latter embodiment may be somewhat less costly to manufacture, and in any event permits the separate disposal of the top layer while continuing to use the lower layer if, for example, extensive scratching were to wear out the upper layer prematurely.

In use the bedding is placed at the bottom of a chicken coop or the like. Birds are then placed on the bedding. When the bedding becomes soiled the coop can be washed down with a garden hose, automatic sprinkler, or other washing system (preferably after temporarily removing the birds). The birds can then be put back on the bedding (when the bedding has sufficiently dried). Eggs, if laid, will tend to move to the depression/cutout (e.g. optionally facilitated by sloping).

The invention is not to be limited to just the preferred embodiments. For example, the mat and cut out could be circular or otherwise rounded. Also, other plastic foam materials having good wearability and drainage properties could be used. Further, there may be embodiments having no depression or cutouts. Hence, in order to ascertain the full scope of the invention the preferred embodiments are not to be considered as the only embodiments. Rather, the claims which follow should be referenced as defining the full scope.

### INDUSTRIAL APPLICABILITY

The invention provides improved bird coop bedding.

We claim:

1. A mattress for a bird coop, the mattress comprising:
a slab comprising a porous plastic foam, the foam being suitable to permit liquid to drain through it if the slab is washed; and
an upper support surface of the slab being formed with an array of tufts that are configured to encourage scratching thereof if a bird is placed on the slab.

2. The mattress of claim 1, wherein the foam is a polyether open cell foam.

3. The mattress of claim 1, wherein the upper support surface of the slab is also formed with a depression suitable to position a laid egg.

4. The mattress of claim 3, wherein the depression was integrally molded into the slab.

5. The mattress of claim 3, wherein the slab is a two layer slab, with the upper layer having a cut-out that forms the depression.

6. The mattress of claim 5, wherein an upper layer of the slab can be separated from a lower layer of the slab, to facilitate separate replacement of the upper layer.

7. The mattress of claim 3, wherein the tufts surround the depression.

8. The mattress of claim 1, wherein the tufts were formed by cutting, in criss-cross fashion, a top surface of the slab.
